(19) United States
(12) Patent Application Publication
(10) Pub. No.: US 2003/0152011 A1
(43) Pub. Date: Aug. 14, 2003

(54) Vibration absorbing mechanism for an optical disk drive

(76) Inventor: Shih-Lin Yeh, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/326,721

(22) Filed: Dec. 19, 2002

(30) Foreign Application Priority Data
Feb. 8, 2002 (TW) 91201752

(51) Int. Cl. G11B 33/02; G11B 17/00; G11B 21/16; G11B 23/00; G11B 25/00

(52) U.S. Cl. 369/75.2; 369/247; 369/263

(57) ABSTRACT

An apparatus for absorb vibration in an optical disk drive. The apparatus includes a chassis, a tray, vibration absorbing dampers and at least one vibration damper, wherein vibration absorbing dampers can be disposed between the tray and the chassis or disposed on the tray.

### BACKGROUND OF THE INVENTION

1. Field of the Invention

The present invention relates to an apparatus for absorbing vibration in an optical disk drive, and in particular to a vibration absorbing mechanism that is more effective in absorbing vibration that may be experienced by the optical disk drive.

2. Description of the Prior Art

An optical disk drive used to read/write the data on an optical disk has been widely used in storage media device. The optical disks drives, such as slim-type optical disk drives, are low in cost and can storage large amounts of data having different contents, such as music, video, programs, and information data.

In attempt to reduce cost and to adapt to limited space constraints, a conventional stepping motor for loading and unloading the optical disk has been eliminated, and a manual loading and ejection device is used to facilitate the loading and unloading operation. Recently, a spindle motor of the optical disk drive is operated at a relatively high rotational speed, centrifugal force due to imbalance of the eccentric disk increases and may lead to vibration or noise. The vibration creates instability that impairs the optical pickup head of the optical disk drive, so that error occurs in data readout, and the noise can be annoying to the user. Accordingly, elimination of vibration and noise at high rotational speeds is a major concern for manufacturers.

FIGS. 1-7 illustrate the conventional slim-type optical disk drive and its vibration absorbing mechanism. As shown in FIGS. 1 and 2, the conventional slim-type optical disk drive has a top cover 1, a chassis 2, two sliding grooves 3, a tray 4, and a playback unit 5. The tray 4 and the playback unit 5 are located inside the chassis 2, and the playback unit 5 is positioned above the tray 4 and a front panel 6 is secured to the tray 4 by screws. When the tray 4 is ejected, the user can place an optical disk on the playback unit 5 and push the front panel 6 causing the tray 4 back into the optical disk drive. That is, the tray 4 can be adapted to slide in and out of the chassis 2 along two sliding grooves 3 in the direction of arrow X1-X2. The tray 4 is locked by a locking mechanism (not shown) that functions to prevent the tray 4 from being inadvertently ejected when the optical disk drive is in use.

As shown in FIGS. 3-5, conventional vibration dampers 9, 10, 11 and 12 are positioned on the tray 4. Typically, the conventional vibration dampers 9, 10, 11 and 12 are made of elastic material to reduce the shock and impact when the disk drive is in use. However, when the optical disk drive is ejected and pushed for a long period, the conventional vibration dampers 9, 10, 11 and 12 will be worn out or damaged because of the nature of conventional vibration dampers 9, 10, 11 and 12 and frequent ejection/loading, as shown in FIGS. 6-8. Further, if the conventional vibration dampers 9, 10, 11 and 12 is broken or worn out, they cannot reduce the shock of the tray 4 and isolate the vibration between tray 4 and chassis 2.

As mentioned, the disadvantages of the conventional optical disk unit must be overcome. Thus, there remains a need for an adjusting device that can constrain and adjust two guide rods with much less manufacturing cycle time and costs.

### SUMMARY OF THE INVENTION

It is an object of the present invention to provide an optical diskdrive with a vibration absorbing mechanism that is more effective in absorbing vibration.

It is another object of the present invention to provide an optical disk drive with a vibration absorbing mechanism that can be adapted to be fit in the slim-type optical disk drive.

In order to accomplish the objects of the present invention, the present invention provides a vibration absorbing mechanism for the optical disk drive. The optical disk drive has a chassis, a tray, a front panel, playback unit and a plurality of vibration absorbing dampers. The vibration absorbing damper is a coil spring and metallic, and all vibration absorbing damper are positioned on tray. The vibration absorbing damper can reduce the shock and vibration when the optical disk drive is in use. Further, the vibration absorbing dampers also isolate the tray and the chassis so that the vibration occurred in the tray cannot be transferred to the chassis.

### BRIEF DESCRIPTION OF THE DRAWING

For a better understanding of the present invention, reference is made to a detailed description to be read in conjunction with the accompanying drawings, in which:

FIG. 1 is a perspective view of a conventional slim-type optical disk drive;

FIG. 2 is a perspective view of FIG. 1 with a top cover removed;

FIG. 3 is a perspective view of FIG. 1 with a top cover and a front panel removed;

FIG. 4 is a perspective view of a tray of FIG. 1;

FIG. 5 is another perspective of a tray of FIG. 4;

FIG. 6 is a cross-sectional view of the conventional slim-type optical disk drive taken along the line A-A of FIG. 2;

FIG. 7 is a partly and enlarged cross-sectional view of conventional vibration absorbing damper indicated by “A” of FIG. 6;

FIG. 8 is a partly and enlarged cross-sectional view of conventional vibration absorbing damper indicated by “B” of FIG. 6;

FIG. 9 is a slim-type optical disk drive according to the present invention;

FIG. 10 is a perspective view of the slim-type optical disk drive according to the present invention with a tray ejected and a top cover removed;

FIG. 11 is an enlarged perspective view of a vibration absorbing damper according to the present invention;

FIG. 12 is a perspective view of FIG. 11 with a chassis removed; and

FIG. 13 is a partly and enlarged perspective view of a vibration absorbing damper indicated by “C” of FIG. 12.

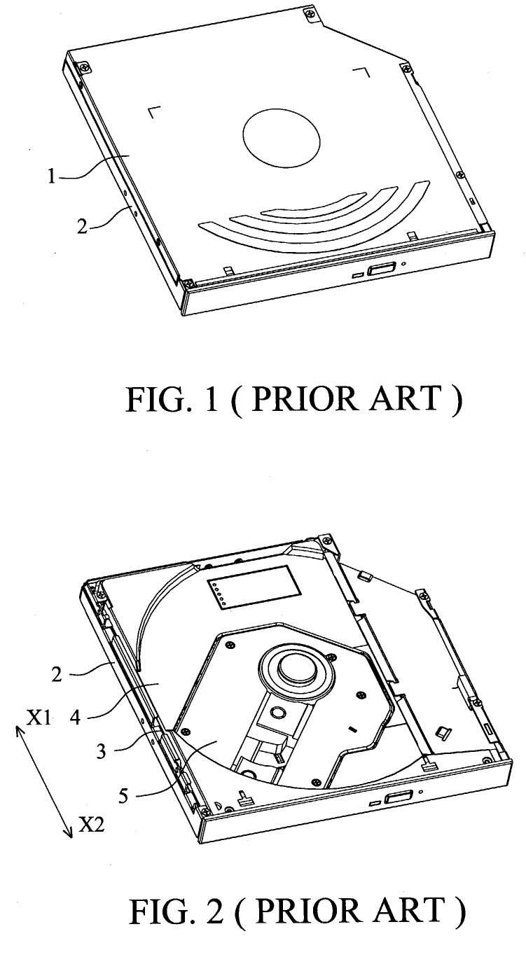

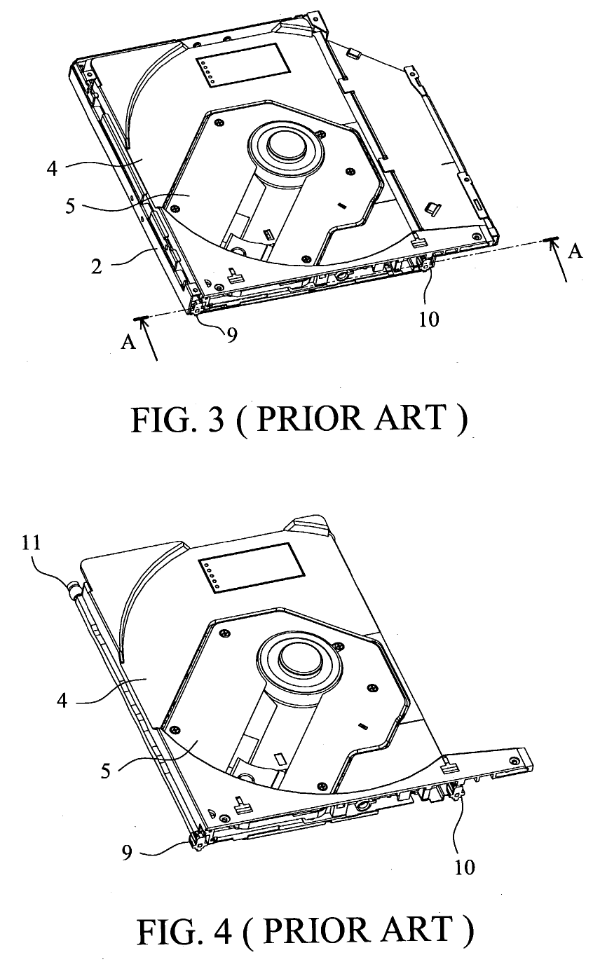

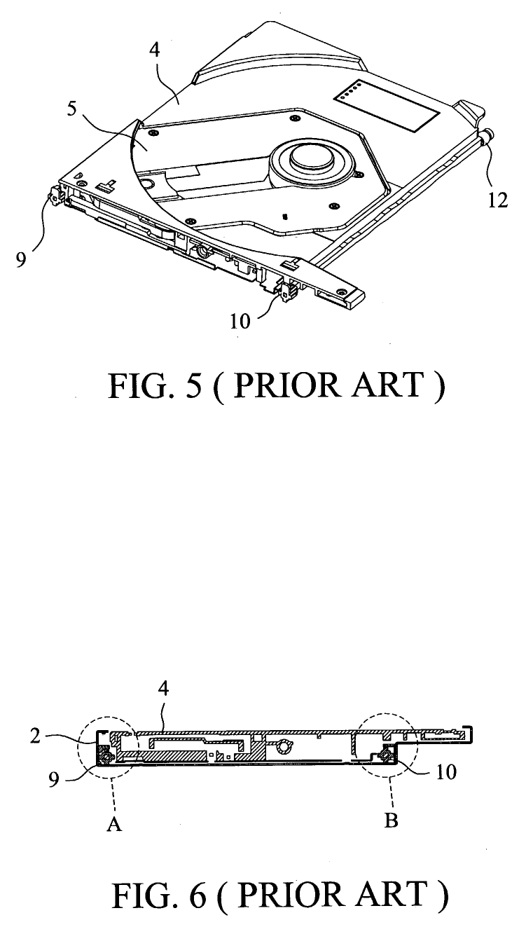

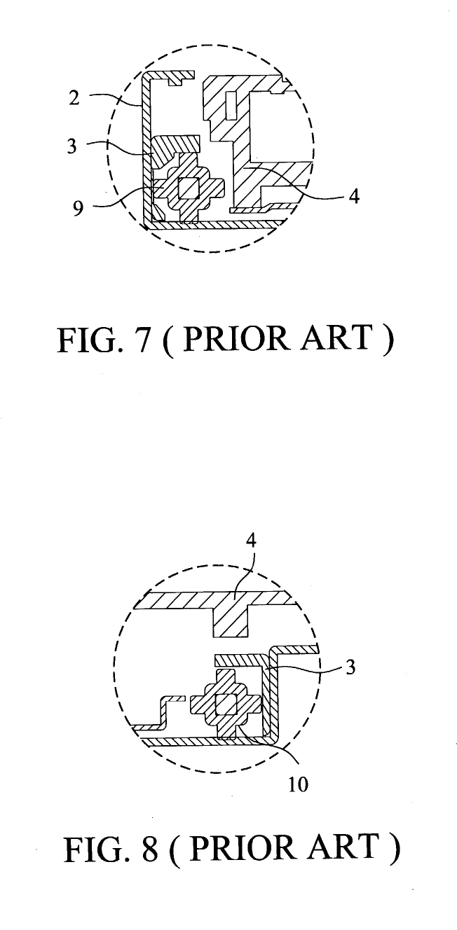

### DETAILED DESCRIPTION OF THE INVENTION

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

Although the principles of the present invention are described below in connection with the DVD-ROM disk drive, the present invention can be applied to all optical disk drive, including but not limited to DVD-ROM drives, DVD-RAM drives, DVD-RW drives and combo drives (DVD-ROM+CD-RW), etc.

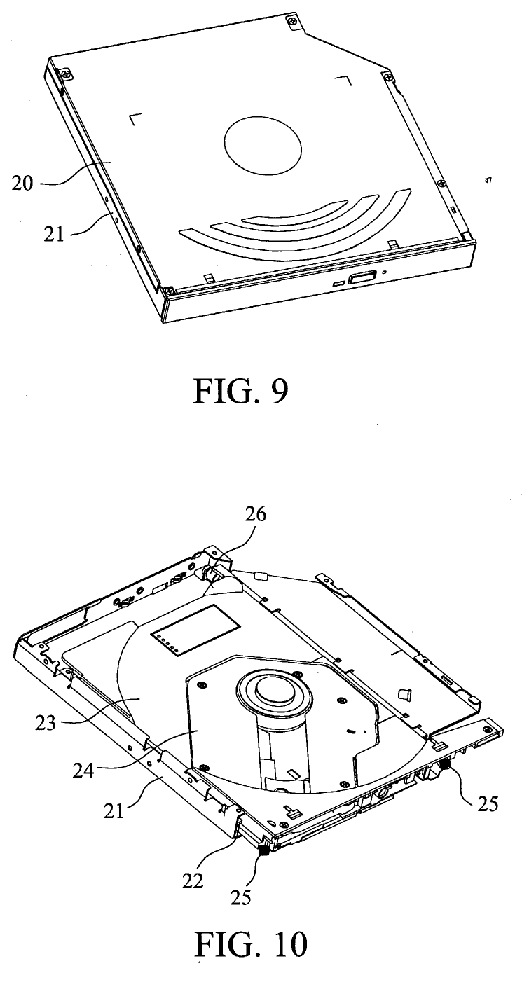

FIGS. 9-13 illustrate a slim-type optical disk drive 1 according to the present invention. Also, FIG. 10 best illustrates the interconnections of the various components of the slim-type optical disk drive 1.

Referring to FIGS. 9 and 10, the slim-type optical disk drive 1 has a top cover 20, a chassis 21, two sliding grooves 22, a tray 23, vibration absorbing dampers 25, 26 and a playback unit 24. Further, a front panel 6 is provided with the tray 23, and a switch button 61 is defined on the front panel 6. When the user pushes a switch button 61, the tray 23 is ejected and the user can easily pull the tray 23 along the sliding grooves 22 in the direction of arrow X2. Meanwhile, the user can place an optical disk on the playback unit 5, and the tray 23 will be pushed back into the chassis 21 in the direction of arrow X1.

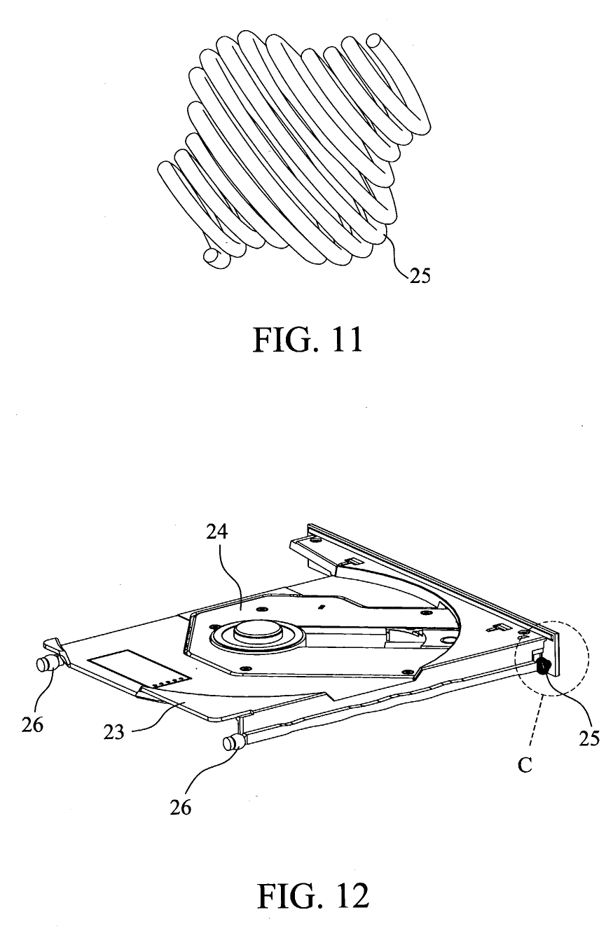

Referring to FIG. 10, the vibration absorbing damper 25, 26 are provided in the tray 23. Because the front panel 6 is secured to the tray 23 by screws (not shown), the vibration absorbing damper 25, 26 can be compressed. FIG. 11 illustrates the vibration absorbing damper 25 according to the present invention. The vibration absorbing dampers 25, 26 are metallic or plastic and resilient, and can be coil springs or equivalents

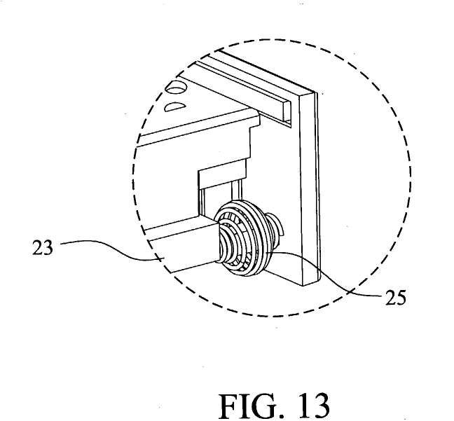

Referring to FIGS. 12 and 13, the vibration absorbing damper 26 abuts a rear end of the chassis 23 and is compressed when the tray 23 is completely pushed back into the chassis 21. As described above, the vibration absorbing damper 25 is provided between the tray 23 and the front panel 6, and is also compressed. After the tray 23 is pushed back into the chassis 21 and the playback unit 24 is in use, vibration from the playback unit 24 occurs. In the regard, the vibration from the playback unit 24 can be transferred to the chassis 21 because the front panel 6 and the vibration absorbing dampers 26 contact the chassis 21. The vibration absorbing dampers 25, 26 can not only reduce and absorb the vibration from the playback unit 24, but also isolate the tray 23 and the chassis 21 by their resilient. That is, the vibration absorbing dampers 25, 26 can prevent the vibration from the tray 23 being transferred to the chassis 21, thereby causing the electrical components vulnerable.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A vibration absorbing mechanism for an optical disk drive, comprising:
a chassis;
a tray, having two silding grooves for sliddably engaging with the chassis;
a playback unit, fixed to the tray;
a plurality vibration absorbing dampers, provided on the tray.

2. The apparatus as claimed in claim 1, wherein the vibration absorbing dampers are metallic or plastic.

3. The apparatus as claimed in claim 1 further comprising vibration absorbing dampers are disposed between the tray and the chassis.

4. The apparatus as claimed in claim 1 further comprising vibration absorbing dampers are disposed on the tray.
